(19) United States
(12) Patent Application Publication
(10) Pub. No.: US 2026/0259471 A1
(43) Pub. Date: Sep. 3, 2026

(54) BLUE LASER OPERATING AT THE H-BETA FRAUNHOFER LINE

(71) Applicant: Aqwest LLC, Larkspur, CO (US)

(72) Inventors: Jan Vetrovec, Larkspur, CO (US); David M. Filgas, Newbury Park, CA (US)

(73) Assignee: Aqwest LLC, Larkspur, CO (US)

(21) Appl. No.: 19/547,644

(22) Filed: Feb. 23, 2026

Related U.S. Application Data
(63) Continuation-in-part of application No. 17/886,290, filed on Aug. 11, 2022, now Pat. No. 12,573,806.
(60) Provisional application No. 63/259,787, filed on Aug. 11, 2021.

(51) Int. Cl. G02F 1/35; H01S 3/08; H01S 3/106; H01S 3/1123; H01S 3/16; H01S 3/23

(52) U.S. Cl. CPC G02F 1/354; H01S 3/08004; H01S 3/106; H01S 3/1123; H01S 3/1616; H01S 3/2308

(57) ABSTRACT

The present invention provides a blue laser transmitter operating at the H-beta Fraunhofer line at 486.13 nm wavelength. The subject blue laser is based on pulsed lasing action in thulium doped into lutetium sesquioxide (Tm:Lu₂O₃). The laser wavelength is restricted by volume Bragg grating to the vicinity of 1944 nm wavelength. The laser is operated with a q-switch to generate high-energy pulses with in the nanosecond regime. The output at the 1944 nm wavelength is then frequency quadrupled in a single pass through non-linear crystals to a wavelength near the center of the H-beta Fraunhofer line. The operation at the 1944 nm wavelength in Tm:Lu₂O₃ is very efficient because this wavelength is located on a shoulder of a substantially broad emission peak at 1945 nm. In addition, at the 1944 nm wavelength, Tm:Lu₂O₃ has only a modest saturation fluence of about 15 J/cm², which allows for efficient energy extraction.

### CROSS-REFERENCE TO RELATED APPLICATIONS

This patent application is a continuation-in-part patent application of U.S. Ser. No. 17/886,290 filed on Aug. 11, 2022 and entitled Blue Laser Operating at the H-Beta Fraunhofer Line, which claims the benefit of U.S. Provisional Patent Application No. 63,259,787, filed Aug. 11, 2021, the entire contents of which are hereby expressly incorporated by reference.

### GOVERNMENT RIGHTS IN THIS INVENTION

This invention was reduced to laboratory practice with U.S. Government support under the U.S. Navy contract nos. N68335-19-C-0491 and N68335-24-C-0166. The U.S. Government may have certain rights in this invention.

### FIELD OF THE INVENTION

This invention relates generally to blue lasers and more specifically to pulsed blue lasers generating coherent radiation with wavelength at the H-beta Fraunhofer line.

### BACKGROUND OF THE INVENTION

There is a strong need for a high peak-power blue laser system for remote detection of underwater objects and bathymetry in bodies of water including rivers, lakes, reservoirs, seas, and oceans. In these applications, the instrument may comprise a blue laser transmitter and a detector, such as shown in FIG. 1. The instrument may be placed or transported over a body of water on a suitable platform (not shown) such as a ship, aircraft, or spacecraft. Alternatively, the instrument may be transported or placed on a underwater platform. The blue laser transmitter directs a transmitter signal laser beam at a predetermined wavelength in the blue spectrum into the body of water. Typically, pulsed laser beam is used. The transmitter signal laser light is at least in-part transmitted into the body of water where it may be at least in-part reflected from underwater objects such as the floor of the body of water, rocks, animals, manmade structures, and floating objects. Such a reflection may be substantially a diffuse reflection. Some of the reflected light will form a reflected return signal delivered into the receiving aperture of the detector. The reflected return signal may be detected by the instrument's sensor (detector) and processed to infer the size, shape, depth, features, and nature of the submerged object. The detector preferably includes a notch filter that allows only the passage of a narrow band of light centered on the laser wavelength. In this manner, underwater objects can be detected and mapped. The transmitter and the detector may not necessarily be collocated. The maximum depth to which this technique is effective may depend on a number of factors including the center wavelength of the laser light, light attenuation in the body of water being surveyed, peak power of the transmitter signal beam, and the energy level of the laser pulses.

There is also a strong need for a high peak-power blue laser system for underwater communication in rivers, lakes, reservoirs, seas, and oceans. In these applications, the communication system may comprise a blue laser transmitter and a receiver, such as shown in FIG. 2 where the entire communication path is under water. Alternative communication systems are shown in FIG. 3A where the transmitter is above the water surface and the receiver is submerged, and FIG. 3B where the transmitter is submerged and the receiver is above the water surface. The submerged transmitter or receiver may be on a manned or unmanned submarine, or submerged equipment or facility, or carried by a diver. For clarity, refraction of transmitter light at the air-water interface is not indicated in FIGS. 1-3. Yet another alternative communication system may include either the transmitter or the receiver placed in space on a satellite or other space vehicle.

A suitable laser transmitter would preferably produce laser light at a wavelength in the blue spectrum in the 460-490 nanometer (nm) range, which corresponds to a favorable transmission band in water. As an example, FIG. 4 has been adapted from a publication by M. G. Solonenko and C. D. Mobley, “Inherent optical properties of Jerlov water types,” Applied Optics, 54, 17, 99 5392-5401, 2015, and its shows the wavelength dependence of the minimum diffuse light attenuation coefficient K_{d} of selected open-ocean water types. Solar irradiance spectrum has a maximum intensity near 500 nm. Therefore, solar irradiance presents a significant background noise to sensing with a blue laser, which makes a reliable detection of the return signal rather challenging. Conditions offering high signal-to-noise ratio (SNR) are very desirable for reliable detection.

Fortuitously, in the preferred 460-490-nm band, the solar output has a relative minimum near 486 nm wavelength when measured in air. This relative (local) minimum is known as the Fraunhofer “F” line. Fraunhofer lines are numerous local minimums in the solar irradiance spectrum, which are caused by absorption of solar radiation by various elements present in the Sun's corona. In particular, the Fraunhofer “F” line known to be at 486.1342 nm wavelength when measured in air (may be further referred to as “486 nm wavelength” or “486.13 nm wavelength” for brevity) is often called the hydrogen-beta or H-beta line to underscore its origins from absorption of solar radiation by hydrogen element in the Sun's corona. A close-up of the solar irradiance spectrum near the H-beta line is shown in FIG. 5, which has been adopted from a publication by F. E. Hanson et al., “Feasibility of a 486 nm Fraunhofer laser source Based on a ⁴F_{3/2}→⁴I_{9/2} neodymium laser,” Technical Report 1480, Naval Command, Control and Ocean Surveillance Center, 1992. Note that at the bottom of the Fraunhofer line (dip), solar irradiance is about 4 to 5 times lower than in the immediate vicinity of the dip. The full width of the dip at half depth is about 0.1 nm (=1 Angstrom). This means, that a blue laser source generating a suitably narrow band signal tuned close to the center of the Fraunhofer H-beta dip may produce a return signal (FIG. 1) that will be more distinct than the corresponding solar background noise. Therefore, the return signal (FIG. 1) offers a superior SNR with respect to continuum, which, in turn allows for a more reliable detection. Alternatively, one may use an instrument with a given output to reach to greater depths of water and still obtain reliable detection. As another alternative, one may use less powerful blue laser pulses that may be generated by a smaller and lighter blue laser transmitter. In this implementation, a blue laser transmitter tuned to the Fraunhofer H-beta line may consume less electric power, require less cooling, may be less costly, and may be deployed on a smaller platform such as unmanned air vehicles (UAVs) or a small spacecraft. Such an instrument could be highly proliferated for mapping, navigation, security, defense, and environmental sensing.

It was noted earlier that the H-beta Fraunhofer line has a very narrow width of about 0.1 nm. This means that a candidate blue laser should have a correspondingly narrow bandwidth (preferably less than 0.05 nm) and a very stable central wavelength.

There are numerous techniques for producing coherent radiation from solid-state laser (SSL) materials. However, the prior art does not disclose a blue laser source capable of advantageous operation at the wavelength corresponding to the H-beta Fraunhofer line at 486 nm with a narrow laser linewidth of 0.05 nm that is also conducive to operation at high-average power and high-pulse energies, while additionally offering compact and lightweight packaging. For example, currently blue lasers with high peak-power capability deployed in remote sensing of underwater objects typically use a quasi- 3 level Nd laser at 946 nm frequency-doubled to 473 nm. Attempts at a Nd-based laser suitable for frequency doubling to the H-beta Fraunhofer line at 486 nm have fallen short of expectations as indicated in the above referenced publication by Hanson.

An alternative approach using a frequency-doubled Ti:sapphire (TiS) laser leads to rather complex and inefficient hardware because it requires pumping by another laser (e.g., a frequency-doubled Nd:YLF) while the TiS gain at 972 nm needed for a second harmonic generation to the desired 486 nm wavelength is impractically low. Semiconductor laser devices such as blue laser diodes (including vertical cavity surface emitting diodes-VCSEL) fall short of the desired high output power and short pulse generation, and they do not meet the wavelength and bandwidth requirements.

Yet another alternative approach using thulium-based upconversion lasers can emit light around 480 nm, typically with tens of milliwatts of output power (REF), but scaling of this approach to the desired average power and pulse energy has not been achieved. An optical parametric oscillator (OPO) is a still another alternative, which can be conveniently tuned to the desired 486.13 nm Fraunhofer H-beta line. However, an OPO has limited wavelength stability and bandwidth, and it must be additionally pumped by another laser, which complicates the blue laser system and limits its efficiency.

Prior art considered frequency quadrupling Tm:YAG and Tm:YLF lasers operating at about 1944 nm. Both of these lasers have high saturation energy, which requires operation at a fluence near damage threshold of optical coatings. This condition makes efficient extraction of stored energy rather challenging.

### SUMMARY OF THE INVENTION

The present invention provides a blue laser transmitter generating laser light at the H-beta Fraunhofer line at the 486.13 nm wavelength measured in air. The subject blue laser comprises a thulium (Tm)-based laser source generating laser light at about 1944.537 nm wavelength when measured in air at standard conditions (may be further referred to as “1944 nm wavelength” for brevity) and a frequency quadrupling system (FQS) for harmonic conversion of the 1944 nm light into coherent light at 486.13 nm corresponding to the H-beta Fraunhofer line in air. The laser source uses a novel laser gain medium (LGM) known as Tm:Lu₂O₃ consisting of tri-valent thulium ions doped into lutetium sesquioxide host (Lu₂O₃). The lutetium sesquioxide host may be a single crystal or ceramic. An alternative LGM may be Tm:Y₂O₃ consisting of tri-valent thulium ions doped into yttrium sesquioxide host (Y₂O₃) or Tm:Sc₂O₃ consisting of tri-valent thulium ions doped into scandium sesquioxide host (Sc₂O₃).

In one preferred embodiment, the laser source may be configured as a power oscillator or as a master oscillator-power amplifier (MOPA). In either case, the laser source is arranged to produce a train of short pulses at a desirable frequency. In particular, a q-switch is employed in either the power oscillator or the master oscillator of the MOPA to generate pulses preferably about 10-30 nanoseconds long. A volume Bragg grating (VBG) mirror for reflecting light in a narrow spectral band centered at 1944.537 nm (closely corresponding to four-times the wavelength of the center of the Fraunhofer H-beta line) is used to control the bandwidth and the center wavelength of the laser source in either oscillator. In particular, the VBG has a spectral bandwidth of less than 0.3 nm full-width at half maximum (FWHM) (preferably less than 0.2 nm, and most preferably less than 0.1 nm), which is arranged to be centered at 1944.537 ±0.100 nm (preferably at 1944.537±0.050 nm) when measured in air at standard conditions. The effective center wavelength of the VBG may be in-part defined by fabrication and in part by temperature tuning when installed in the laser.

The operation at the 1944 nm wavelength in Tm:Lu₂O₃ laser gain medium (LGM) is very efficient because this wavelength resides on the shoulder of a substantially broad emission peak at about 1945 nm, FIG. 6. In addition, at the 1944 nm wavelength, Tm:Lu₂O₃ has only a modest saturation fluence of about 15J/cm² , which allows for efficient energy extraction at only a modest fluence (measured as a pulse energy per unit of area). In comparison to traditional materials, the Tm:Lu₂O₃ LGM has a saturation fluence about 2× less than Tm:YLF and about 3× less than Tm:YAG, more favorable spectroscopy, isotropy, superior thermal conductivity. In addition, the Tm:Lu₂O₃ LGM is now available in ceramic form (see e.g., O. L. Antipov et al. in “Optical properties and efficiency laser oscillation at 2066 nm of novel Tm:Lu2O3 ceramic published on Feb. 1, 2012 in Optical materials express), which offers making much larger-size components than by growing crystals from the melt or by using the hydrothermal process. The hydrothermal process is described for example by Colin McMillen et al., in “Hydrothermal single-crystal growth of Lu₂O₃ and lanthanide-doped Lu₂O₃,” published on Aug. 11, 2011 in Cryst. Growth & Design Journal, pages, 4386-4391.

The FQS performs harmonic frequency conversion via non-linear crystals preferably in two steps. In the first step, the frequency corresponding to the fundamental wavelength of 1944 nm is doubled in a first nonlinear crystal, thus producing laser light at a first harmonic wavelength of about 972 nm. In the second step, the first harmonic wavelength of 972 nm is doubled in a second nonlinear crystal, thus producing laser light at a second harmonic at a wavelength of about 486.13 nm corresponding to center of the H-beta Fraunhofer line. The choice of the non-linear crystals for each step is selected to optimize the conversion process. The resulting frequency-quadrupled Tm:Lu₂O₃ laser offers a powerful blue transmitter for an increased standoff range in a very efficient, compact, lightweight, and robust package.

It is the object of the invention to provide a blue laser transmitter generating laser light at 486.13 nm wavelength when measured in air at sea level and corresponding to the H-beta Fraunhofer line.

It is another object of the invention to provide an efficient blue laser for remote detection and/or imaging of underwater objects and bathymetry in bodies of water including rivers, lakes, reservoirs, seas, and oceans.

It is yet another object of the invention to provide a blue laser transmitter for mapping of underwater objects for security, defense, and environmental purposes.

It is still another object of the invention to provide a blue laser transmitter for sensing the environmental state of bodies of water including rivers, lakes, reservoirs, and oceans.

It is a further object of the invention to provide a blue laser transmitter for underwater communication.

It is a yet further object of the invention to provide a narrow linewidth blue laser transmitter for imaging of underwater objects.

It is a still further still object of the invention to provide a narrow linewidth blue laser transmitter for underwater communication.

These and other objects of the present invention will become apparent upon a reading of the following specification and claims.

### BRIEF DESCRIPTION OF THE DRAWINGS

FIG. 1 is schematic diagram showing a concept for remote detection of underwater objects with a blue laser remote sensing instrument.

FIG. 2 is schematic diagram showing a concept for underwater communication with a blue laser transmitter.

FIG. 3A is schematic diagram showing a concept for underwater communication with a blue laser transmitter where the transmitter is above the water surface and the receiver is submerged.

FIG. 3B is schematic diagram showing a concept for underwater communication with a blue laser transmitter where the receiver is above the water surface and the transmitter is submerged.

FIG. 4 is a plot of the minimum diffuse light attenuation coefficient of selected open-ocean water types that has been adapted from a publication by M. G. Solonenko and C. D. Mobley, “Inherent optical properties of Jerlov water types,” Applied Optics, 54, 17, 99, pages 5392-5401, 2015.

FIG. 5 is a close-up view of the solar irradiance spectrum near the H-beta line, which has been adopted from a publication by F. E. Hanson et al., “Feasibility of a 486 nm Fraunhofer laser source Based on a ⁴F_{3/2}→⁴I_{9/2} neodymium laser,” Technical Report 1480, Naval Command, Control and Ocean Surveillance Center, 1992.

FIG. 6 is a plot of the spectral gain of Tm:Lu₂O₃ at selected levels of inversion (beta) and indicating the relative positions of the natural emission peak at 1945 nm and the targeted fundamental lasing wavelength of 1944 nm suitable for frequency quadrupling to the H-beta Fraunhofer line at 486 nm, which has been adopted from a doctoral dissertation thesis by P. Koopmann, “Thulium and Holmium-Doped Sesquioxides for 2 μm Lasers,” submitted in 2012.

FIG. 7 is a schematic diagram showing the blue laser transmitter of the subject invention.

FIG. 8 is a schematic diagram showing the blue laser transmitter of the subject invention used with a modulator suitable for communication.

FIG. 9 is a schematic diagram showing another embodiment of the laser source of the blue laser transmitter of the subject invention suitable for use with planar waveguide (PWG) LGM.

FIG. 10 is a schematic diagram showing yet another embodiment of the laser source of the blue laser transmitter of the subject invention suitable for use with a reflective VBG.

FIG. 11 is a schematic diagram showing still another embodiment of the laser source of the blue laser transmitter of the subject invention suitable for generating a coherent light output with narrow line width (NLW).

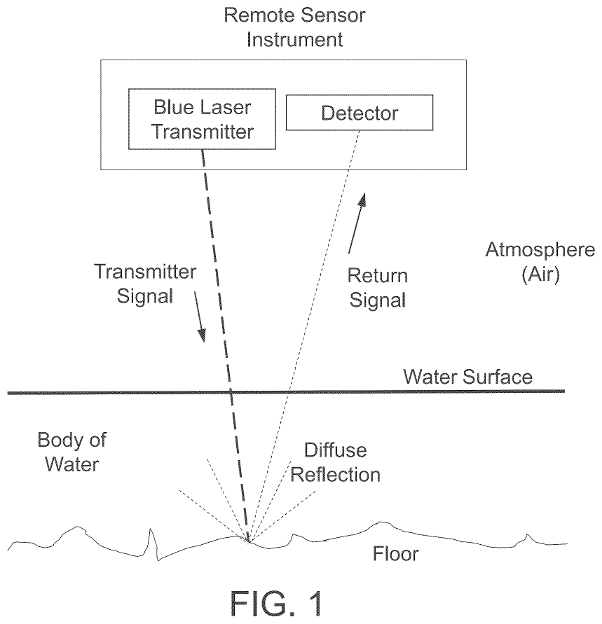

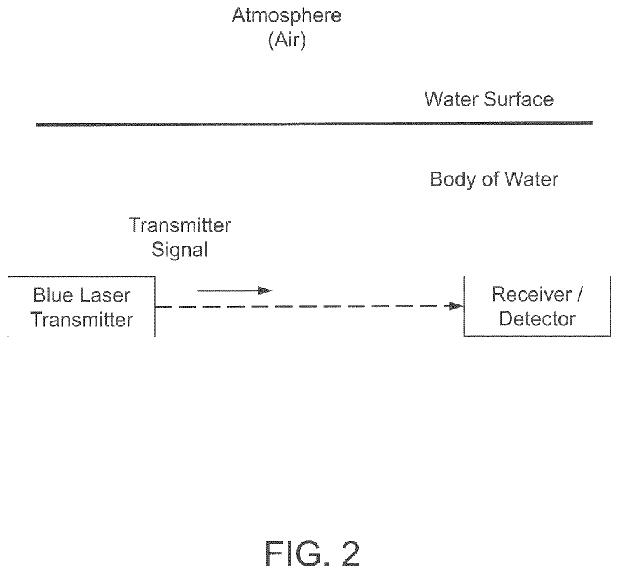

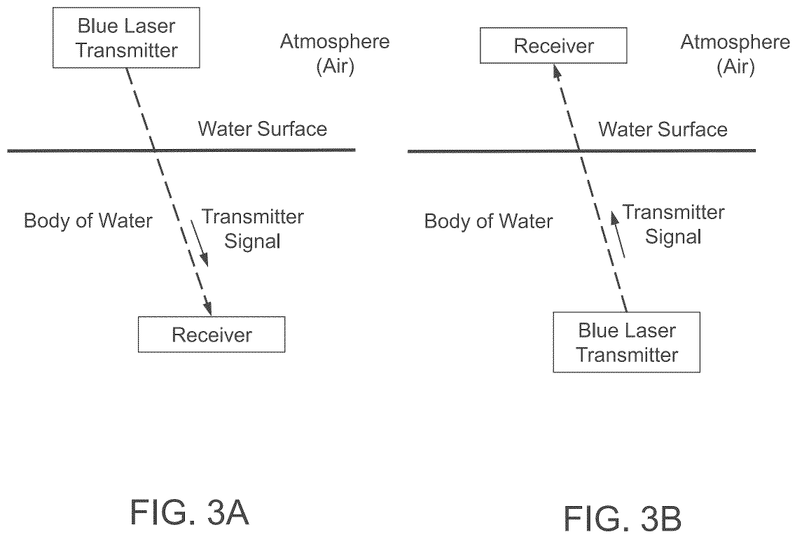

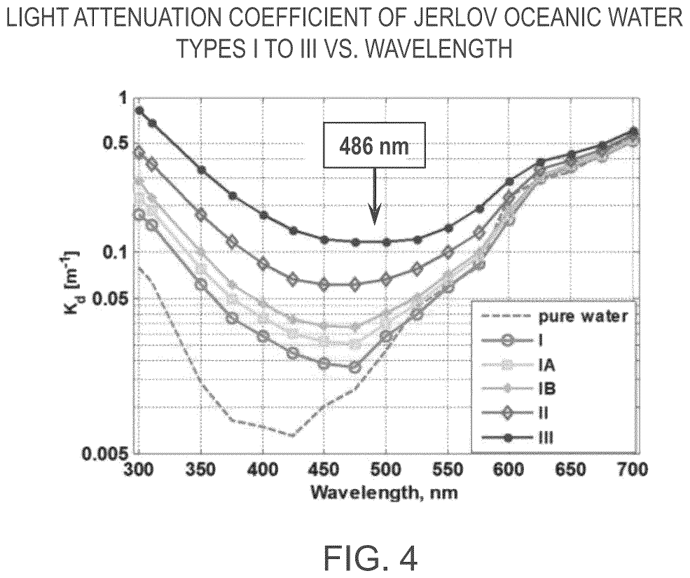

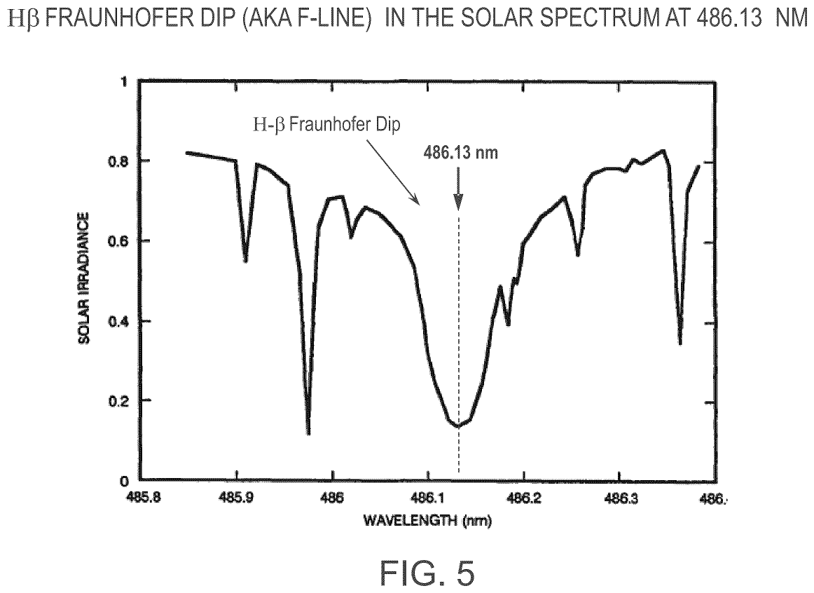

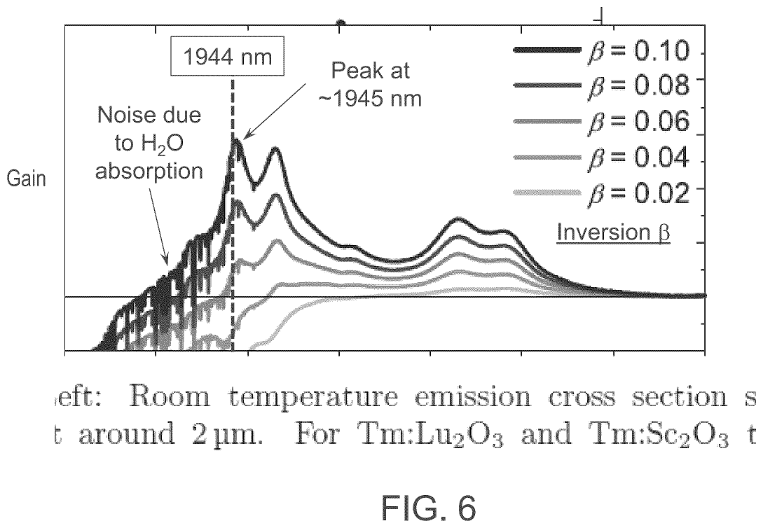

### DETAILED DESCRIPTION OF THE PREFERRED EMBODIMENTS

Selected embodiments of the present invention will now be explained with reference to drawings. In the drawings, identical components are provided with identical reference symbols in one or more of the figures. It will be apparent to those skilled in the art from this disclosure that the following descriptions of the embodiments of the present invention are merely exemplary in nature and are in no way intended to limit the invention, its application, or uses.

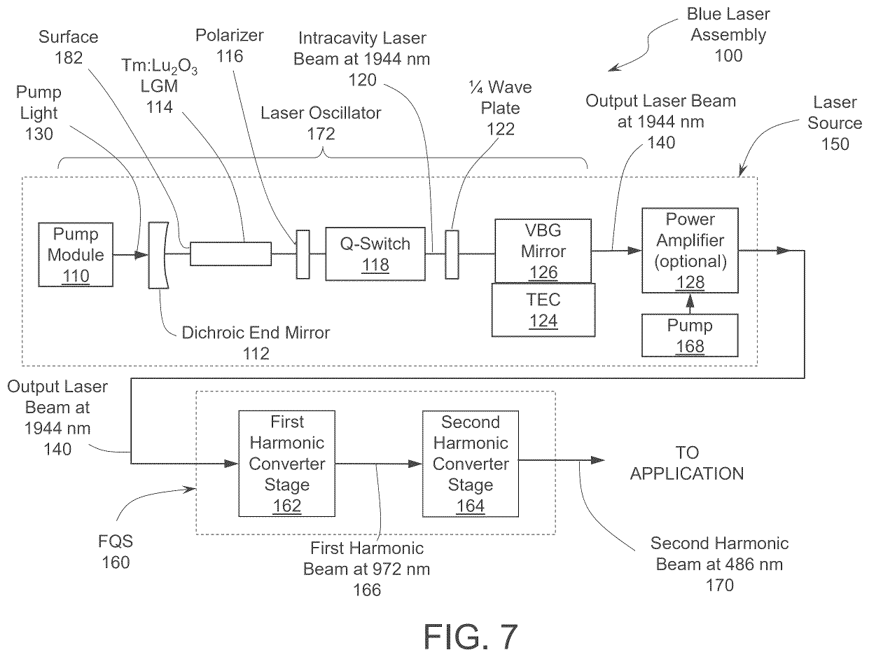

Referring now to FIG. 7, there is shown a blue laser assembly 100 in accordance with one preferred embodiment of the present invention. The blue laser assembly 100 comprises a laser source 150 and a frequency quadrupling system (FQS) 160. The laser source 150 further comprises a laser oscillator 172 consisting of a pump module 110, dichroic end mirror 112, Tm:Lu₂O₃ laser gain medium (LGM) 114, polarizer 116, q-switch 118, quarter wave plate 122, and volume brag grating (VBG) outcoupling mirror 126. In some variants of the subject invention, the laser source 150 may also include a power amplifier (PA) 128 that may be used to boost the energy of the output laser pulses before conveying them to the FQS 160. The dichroic end mirror 112 and the VBG mirror 126 form a laser resonator cavity.

The pump module 110 may be a laser diode generating pump light 130 at about 792 to 796 nm, or at about 1670 nm, or in the range of about 1600-1944 nm. As another alternative, the pump module 110 may be an erbium fiber laser Raman-shifted to deliver pump light at about 1670 nm as described by O. Antipov in “Highly efficient 2 μm CW and Q-switched Tm3+:Lu2O3 ceramic lasers in-band pumped by a Raman-shifted erbium fiber laser at 1670 nm,” published in Optics Letters Vol. 41, No. 10/May 15, 2016. While this approach adds complexity, it offers improved lasing efficiency and reduced waste heat in the Tm:Lu₂O₃ LGM. As yet another alternative, the pump module 110 may be a thulium fiber laser generating a pump light in the range of about 1700-1900 nm. Improved lasing efficiency and reduced waste heat offers to offset the added complexity of this approach. The dichroic end mirror 112 is made of material with good transmission at the pump wavelength and it is coated for high reflectivity at the lasing wavelength around 1944 nm and for very low reflectivity/high transmission at the pump wavelength on the side facing the LGM 114 and for very low reflectivity/high transmission at the pump wavelength on the side facing the pump module 110. The dichroic end mirror 112 may have a convex surface on the side facing the LGM 114. The LGM 114 is made of Tm:Lu₂O₃ material, which may be in a single crystal or ceramic form. Preferred Tm doping levels are between 1 and 2% atomic. The LGM 114 may be configured as a rod, fiber, disk, thin slab, or a planar waveguide (PWG).

The q-switch 118 may be either acousto-optic, electro-optic, or a passive (saturable) light modulator. The VBG 126 is of the partially reflective type and it is preferably arranged to be in the range of about 30% reflective and 70% transmissive to 90% reflective and 10% transmissive at the center wavelength of 1944.537±0.100 nm (preferably 1944.537±0.050 nm) when measured in air at standard conditions. The VBG 126 preferably has a bandwidth of less than 0.3 nm full-width at half maximum (FWHM) (preferably less than 0.2 nm, and most preferably less than 0.1 nm). The VBG 126 is optionally mounted on and in good thermal communication with a TEC 124 (thermoelectric cooler). TEC devices are known to be capable of heating as well as cooling. Controlling the TEC temperature allows for precise temperature tuning of the VBG central wavelength. An alternative to using a TEC is to use a heating source such as an electric heater. The PA 128 may be provided as needed to boost the energy of the output laser pulses of the oscillator 172 before conveying them to the FQS 160. The PA 128 uses its own Tm:Lu₂O₃ LGM that may be configured as a rod, fiber, planar waveguide (PWG), thin slab, or a disk. Further PA 128 may use its own pump 168.

The FQS 160 comprises a first harmonic converter stage 162 and a second harmonic converter stage 164. The first harmonic converter stage 162 uses a suitable nonlinear crystal (such as periodically-pooled lithium niobate (PPLN), potassium titanyl phosphate (KTP), and Lithium niobate (LiNbO3)) for conversion of the output beam 140 at 1944 nm wavelength into a first harmonic beam 166 at about 972 nm wavelength. The second harmonic converter stage 164 uses a suitable nonlinear crystal (such as periodically-pooled lithium niobate (PPLN), potassium niobate (KNbO3), barium borate (BBO), or lithium triborate LBO) for conversion of the first harmonic beam at about 972 nm wavelength into a second harmonic beam 170 at 486.13+/−0.025 nm (preferably 486.13+/−0.013 nm) wavelength when measured in air and closely corresponding to the center wavelength of the Fraunhofer H-beta line. Preferably the first harmonic converter stage 162 and the second harmonic converter stage 164 are arranged for efficient harmonic conversion in a single pass through their respective non-linear crystals, thus offering a simple layout. This is possible by providing the beam 140 with pulse energy, pulse length, and beam size to attain beam intensities at which single pass through the non-linear crystals converts much of the pulse energy into a harmonic.

In operation, the pump module 110 generates pump light 130 and injects it through the dichroic end mirror 112 into the LGM 114 where it is largely absorbed. Absorbed pump light pumps Tm ions into the upper laser level according to a known process. With the q-switch 118 being closed shut, there is absence of a suitable optical feedback, thus, laser energy may be momentarily stored in the LGM. At predetermined times, the q-switch 118 is arranged to open and pass therethrough 1944 nm light. This, in turn, allows the VBG 126 to receive optical radiation from the LGM 114 and reflect some of it back, thus providing optical feedback to the LGM. As a result, laser oscillations commence, and the energy stored in the LGM 114 is transferred into the intracavity beam 120. The intracavity oscillations may last for a few nanoseconds to about 100 nanoseconds (preferably 10 to 30 nanoseconds), which may significantly depend on the configuration of the laser resonator, especially the physical separation of the dichroic mirror 112 and the VBG outcoupling mirror 126. A portion of the intracavity beam 120 passes through the VBG 126 and forms the output laser beam 140. The output laser pulse may be on the order of a few nanoseconds to about 100 nanoseconds long but preferably it is 10 to 30 nanoseconds long. If necessary, the pulse energy of the output laser beam 140 may be further boosted in the PA 128 before being injected into the FQS 160. Pulsing of the laser may be repeated at suitable repetition rate. Typical pulse repetition rate may be as low as a single pulse, or few Hz, or as high as hundreds of kilohertz range.

In the FQS 160, the laser beam 140 at 1944 nm wavelength is fed into the first harmonic converter stage 162 and substantially converted to a first harmonic beam 166 at 972 nm wavelength in a single pass through the non-linear crystal. The unconverted portion of the fundamental beam at 1944 nm wavelength may be removed by a dichroic beam splitter (not shown). The first harmonic beam 166 at 972 nm wavelength is now fed to the second harmonic converter stage 164 and substantially converted to a second harmonic beam 170 at 486 nm wavelength in a single pass through the non-linear crystal which. The resulting second harmonic beam 170 may be provided to an application. The unconverted portion of the first harmonic beam at 972 nm wavelength may be removed by a dichroic beam splitter (not shown).

In some variants of the invention, the dichroic mirror 112 in FIG. 7 may be omitted and the surface 182 of the LGM 114 facing the pump module 110 may be coated with a dichroic coating for high reflectivity at the lasing wavelength around 1944 nm and for very low reflectivity/high transmission at the pump wavelength.

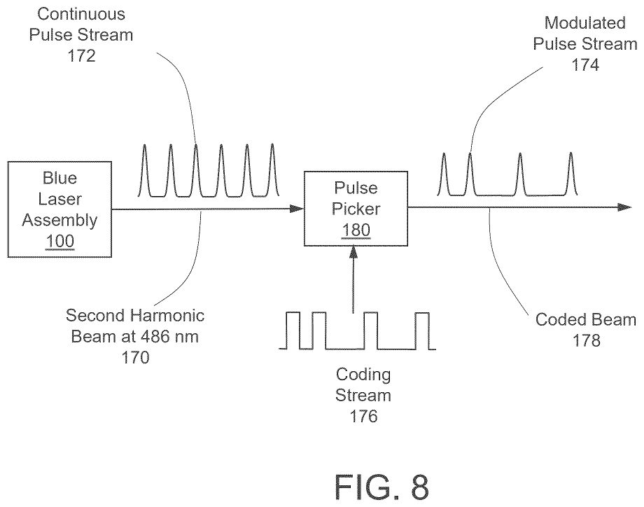

Referring now to FIG. 8 there is shown a blue laser assembly 100 operating with a modulator 180 as a part of a transmitter that may be used for communication of information. In particular, the blue laser assembly 100 generates a second harmonic beam 170 at 486.13 nm wavelength comprising a continuous pulse stream 172, which are directed into the modulator 180. The modulator 180 is provided with a coding stream 176 and it accordingly modulates the beam 170 with the continuous pulse stream 172 into a coded beam 178 having a modulated pulse stream 174.

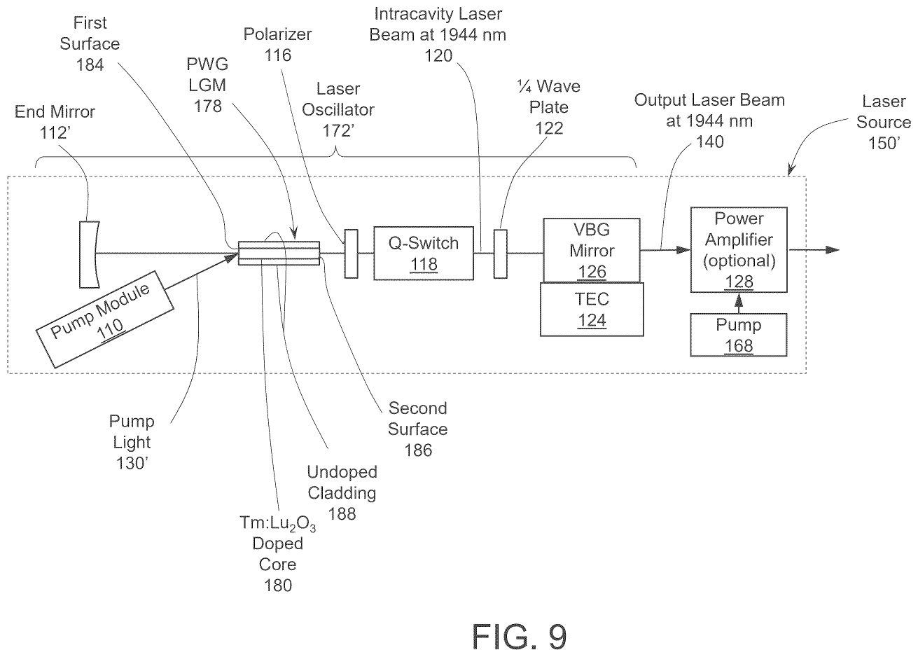

The blue laser assembly 100 of FIG. 7 may use alternative versions of the laser source 150. Referring now to FIG. 9, there is shown one alternative laser source 150′, which offers operation at higher average power and pulse energy. The alternative laser source 150′ is similar to the laser source 150 except that instead of the Tm:Lu₂O₃ LGM 114 it uses a planar waveguide (PWG) LGM 178. It is well known in the art that PWG LGM is conductive to operating at generally higher average power and pulse energy while delivering good beam quality than, for example, rod-type LGM. See, for example, “Dielectric solid-state planar waveguide lasers” by J. I. Mackenzie, published in IEEE Journal of Selected Topics in Quantum Electronics, Vol. 13, pp. 626-637, May-Jun 2007.

The PWG LGM 178 comprises a core 180 made of Tm:Lu₂O₃ ceramic and it may also include one or more claddings 188. The cladding 188 not substantially doped by Tm ions and it is preferably made from undoped Lu₂O₃ ceramic. The cladding 188 is optically bonded to the core 180. Preferred bonding technique has been disclosed, for example, in U.S. Pat. No. 5,441,803 awarded to Meissner. Alternative bonding technique has been disclosed by the Applicants in U.S. patent application Ser. No. 18/371,321, now pending. The PWG LGM further comprises a first surface 184 and a second surface 186, each of which may be substantially normal to the path of the intracavity laser beam 120 or may be slightly (<20 degrees) tilted from normal. The first surface 184 is coated to be antireflective at the 1944 nm laser wavelength and also antireflective at the pump wavelength (e.g., about 792-796 nm). The second surface 186 may be coated in the same manner as the first surface 184, however, it is preferably coated to be antireflective at the 1944 nm laser wavelength and highly (>about 90%) reflective at the pump wavelength. The latter approach allows for the pump light to make two passes through the PWG LGM 178, thus offering improved pump absorption. The end mirror 112′ is coated to be antireflective at the 1944 nm laser wavelength. The pump module 110 is preferably arranged so that the pump light 130′ enters the first surface 184 at a small (<20 degrees) angle. Alternatively, the pump light may be injected into the PWG LGM 178 via a dichroic optic or a polarizer.

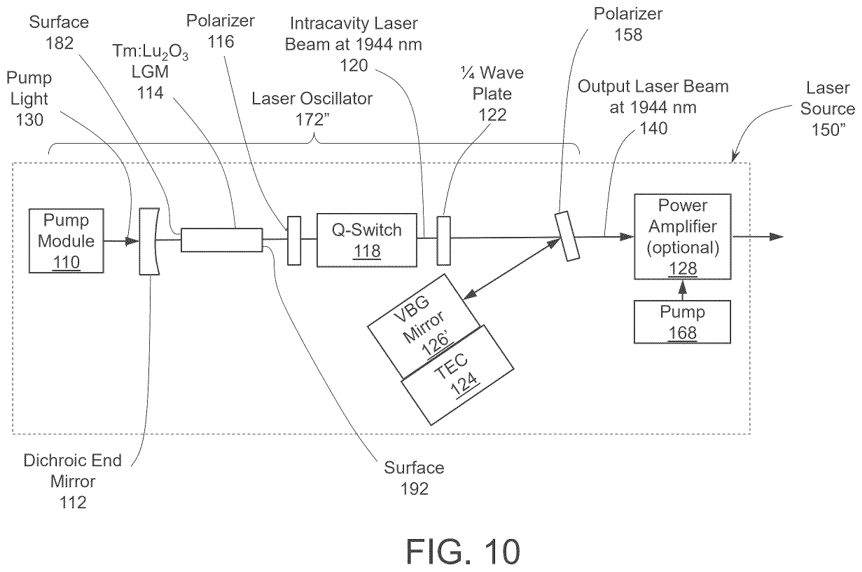

Referring now to FIG. 10, there is shown another alternative laser source 150″ which allows for the use of reflective VBG. The alternative laser source 150″ is similar to the laser source 150 except that instead of the partially reflective VBG 126 it uses a reflective VBG 126′ in combination with a polarizer 158 acting as the outcoupling element in the resonator cavity. The reflective VBG 126′ is arranged to be highly (>80%) reflective at the center wavelength of 1944.537±0.100 nm (preferably 1944.537±0.050 nm) when measured in air at standard conditions and have low reflectivity (<10%) outside this range. The polarizer 158 is positioned in the cavity of the laser oscillator 172″ to receive the intracavity beam 120 and it is tilted so as to direct the reflected light onto the VBG 126′, which is positioned to the side. The VBG 126′ is tilted to reflect a high portion of the incident light in the range of 1944.537±0.100 nm (preferably 1944.537±0.050 nm in air) back onto the outcoupling mirror 158, which directs a significant portion of this light toward the LGM 114. Polarization output coupling through the polarizer 158 is defined by the effective reflectivity of the cavity of the laser oscillator 172″, which is set by the rotation of the quarter wave plate 122. The portion of incident intracavity beam 120 transmitted through the polarizer 158 forms the output laser beam 140.

Single-frequency pulsed lasers (having high spectral purity) are required for many applications, such as spectroscopy, nonlinear optics, laser communications, differential absorption lidar (DIAL) and coherent lidar. Generally, injection seeding is one of the most common techniques to obtain single-longitudinal-mode pulsed laser output in nanosecond scale. By injecting a low power narrow-linewidth (NLW) continuous wave (CW) seed laser, the cavity of the (slaved) laser oscillator is prepopulated with photons from the seed laser source, and mode competition in cavity will lead to single-longitudinal-mode output from the slave cavity. To attain reliable injection seeding requires the length of the laser oscillator cavity to be adjusted in resonance with the frequency of the NLW seeder laser at the time of laser opening the q-switch. This adjustment may be done by the outcoupling mirror placed on piezo actuators that can be electronically controlled to make the laser cavity longer or longer. Alternatively, the optical cavity length may be adjusted by and intracavity phase modulating element such as disclosed in “Injection seeded single-frequency pulsed Nd:YAG laser resonated by an intracavity phase modulator” by J. Zhang et al., and published in Applied Optics Vol. 53, No. 31 on Nov. 1, 2014.

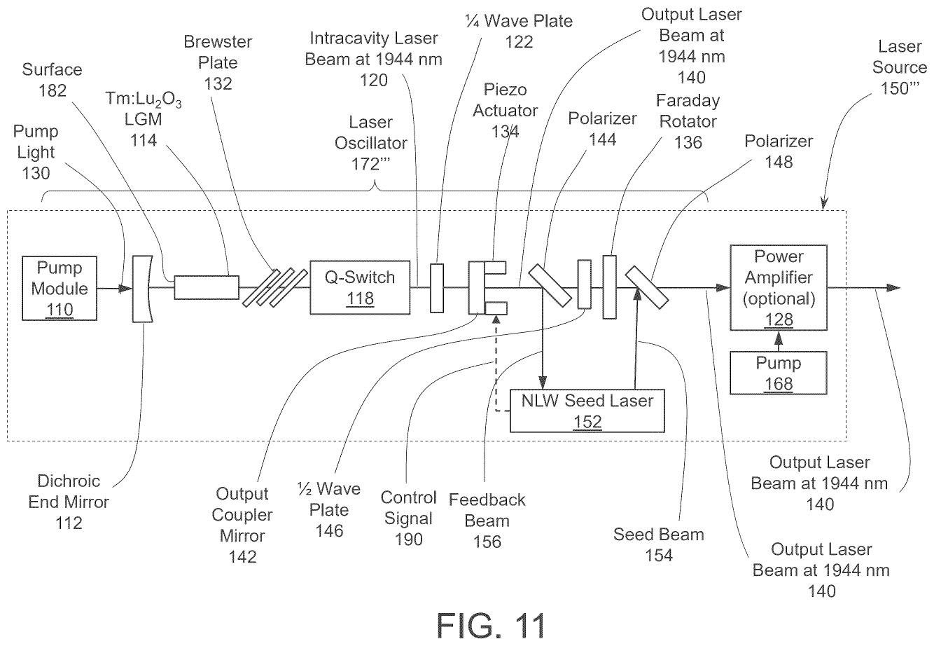

Referring now to FIG. 11, there is shown yet another alternative laser source 150′″, which is arranged to generate a narrow line width (NLW) spectral content in the output beam 140. The alternative laser source 150″′ is similar to the laser source 150 except that a narrow linewidth (NLW) seed laser 152 is used to seed the cavity of the laser oscillator 172″′. In one variant of the invention, the NLW seed laser 152 provides a seed beam with the wavelength center line at 1944±0.05 nm and a <50 kHz spectral line width (heterodyne), and >10 GHz tuning range. Suitable seed lasers are available commercially, for example, from NP Photonics Inc. in Tucson, AR.

There is a variety of architectures for seeded laser oscillators. One preferred approach shown in FIG. 11 uses the laser oscillator 172″′ cavity defined by the end mirror 112 and the output coupling mirror 142. The cavity also includes a Q-switch 118, one or more Brewster plates 132, and a quarter wave plate 122. The output coupling mirror 142 is suspended three piezo actuators 134. The front surface (facing the Q-switch 118) of the output coupling mirror 142 is coated to be in the range of about 30% reflective and 70% transmissive to 90% reflective and 10% transmissive at the 1944 nm wavelength. The opposite face of the output coupling mirror 142 is coated to be antireflective at the 1944 nm wavelength.

The seeding optics uses polarizers 144 and 148, one or more Brewster plates 132, a half-wave plate 146, and a Faraday rotator (arranged for 90 degree rotation of the polarization plane). The NLW seeder laser 152 is arranged to direct a seed beam 154 onto the polarizer 148 where it is reflected and sent through the output coupling mirror 142 into the laser cavity. The polarizer 144 is arranged to separate a small portion of the output laser beam 140 downstream of the output coupling mirror 142 and send it as a feedback beam 156 to the NLW seed laser.

In operation, when the Q-switch 118 opens up, the seed beam 154 from the NLW seed laser 152 fills the cavity of the laser oscillator 172′″. If the seed light presents the strongest signal in the cavity, it will be preferentially amplified at the expense of other (undesirable) cavity modes. The resulting pulse of the output laser beam 140 will have substantially same spectral features as the seed beam 154 but with much higher intensity. Spectral broadening of the output beam 140 may occur due to short laser pulse duration, technical noise, as well as other effects known in the art. As a result, the output laser beams 140 (FIGS. 11) and 170 (FIG. 7) may have a NLW in the range of megahertz (MHz) to gigahertz (GHz). A small portion of the output laser beam 140 is separated by the polarizer 144 and sent as a feedback beam 156 to the NLW seed laser 152 for processing by the control system. As necessary, the control system sends control signals 190 to the piezo actuators 134 to adjust the position of the output coupling mirror 142 and thus adjust the cavity length. In this fashion, the laser cavity length is prepared for future pulses.

Another preferred embodiment of the present invention may use Tm:Y₂O₃ LGM in lieu of the Tm:Lu₂O₃. While Tm:Y₂O₃ is deemed to have a lower gain at 1944 nm wavelength than Tm:Lu₂O₃, it offers lower cost due to the higher abundance of the yttrium element (Y).

Yet another preferred embodiment of the present invention may use Tm:Sc₂O₃ LGM in lieu of the Tm:Lu₂O₃. Tm:Sc₂O₃ is deemed to have a lower gain at 1944 nm than Tm:Lu₂O₃.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” and “includes” and/or “including” when used in this specification, specify the presence of stated features, integers, steps, operations, elements, and/or components, but do not preclude the presence or addition of one or more other features, integers, steps, operations, elements, components, and/or groups thereof.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

The term “suitable,” as used herein, means having characteristics that are sufficient to produce a desired result. Suitability for the intended purpose can be determined by one of ordinary skill in the art using only routine experimentation.

Moreover, terms that are expressed as “means-plus function” in the claims should include any structure that can be utilized to carry out the function of that part of the present invention. In addition, the term “configured” as used herein to describe a component, section or part of a device includes hardware and/or software that is constructed and/or programmed to carry out the desired function.

The terms “Fraunhofer F line”, “Fraunhofer H-beta line”, “H-beta Fraunhofer line”, and “H-beta Fraunhofer dip” refer to the dip in solar radiation spectrum with its center known to be at 486.1342 nm wavelength when measured in air.

The terms “486 nm wavelength” and “486.13 nm wavelength” refer to the center wavelength of the Fraunhofer H-beta line. The terms “1944 nm wavelength” and “1944 nm wavelength” refer to the 1944.537 nm wavelength measured in air at standard condition, which is about four times the wavelength of the Fraunhofer H-beta line.

The term “standard conditions” means air at 100 kilopascals pressure, 20 degrees Celsius temperature, 50% relative humidity, and carbon dioxide content of 450 parts per million.

Different aspects of the invention may be combined in any suitable way.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments.

While only selected embodiments have been chosen to illustrate the present invention, it will be apparent to those skilled in the art from this disclosure that various changes and modifications can be made herein without departing from the scope of the present invention as defined in the appended claims. Furthermore, the foregoing description of the embodiments according to the present invention are provided for illustration only, and not for the purpose of limiting the present invention as defined by the appended claims and their equivalents. Thus, the scope of the present invention is not limited to the disclosed embodiments. What is claimed is:

1 A blue laser system comprising a laser source and a frequency quadrupling system (FQS);
a) said laser oscillator including a pump module, a dichroic mirror, a laser gain material, a polarizer, a q-switch, a one-quarter wave plate, and a volume Bragg grating (VBG);
b) said laser source being arranged as a laser oscillator;
c) said laser gain element selected from the family consisting of Tm:Lu₂O₃, Tm:Y₂O₃, and Tm:Sc₂O₃;
d) said VBG being arranged to restrict lasing in said laser oscillator to a wavelength of 1944.537 ±0.100 nm measured in air at standard conditions; and
e) said FQS comprising a non-linear crystal wherein laser light resulting from said lasing at said 1944.537 ±0.100 nm arranged to be converted in said FQS to a wavelength in the vicinity of 486.13 nm measured in air at sea level and corresponding to the vicinity of the H-beta Fraunhofer line.

2. The blue laser system of claim 1, wherein said laser gain material is in a ceramic form.

3. The blue laser system of claim 1, wherein said laser source further includes a power amplifier.

4. The blue laser system of claim 1, further including a TEC in good thermal contact with said VBG.

5. The blue laser system of claim 4, wherein the temperature of said TEC is adjusted so that the center wavelength of said laser light wavelength in the vicinity of 486.13 nm is arranged to be within 0.025 nm of the Fraunhofer H-beta line center at 486.13 nm wavelength measured in air at sea level.

6. The blue laser system of claim 1, further including a pump module for generation of pump light; said module selected from the family consisting of laser diode, thulium fiber laser, and Raman-shifted erbium laser.

7. The blue laser system of claim 6, wherein said pump light in the vicinity of wavelengths selected from the family consisting of 796 nm, 1670 nm, and 1700-1900 nm.

8. The blue laser system of claim 1, wherein said volume Bragg grating is arranged to restrict said lasing to the wavelength band of <0.2 nm.

9. The blue laser system of claim 1, wherein said laser oscillator is operated with the q-switch to generate a train of 10-30 nanosecond pulses.

10 The blue laser system of claim 1, wherein said FQS comprises a non-linear crystal arranged to frequency double said output at said 1944 nm wavelength to the vicinity of 972 nm wavelength in a single pass through said crystal.

11 The blue laser system of claim 1, wherein said wherein said FQS comprises a non-linear crystal arranged to frequency double said 972 nm wavelength to the vicinity of 486 nm wavelength in a single pass through said crystal.

12. A blue laser system comprising a laser source and a frequency quadrupling system (FQS);
a) said laser oscillator including a pump module, a dichroic mirror, a laser gain material, a polarizer, a q-switch, a one-quarter wave plate, and a volume Bragg grating (VBG), a TEC, a power amplifier, and a pump;
b) said laser source being arranged as a laser oscillator;
c) said laser gain element selected from the family consisting of Tm:Lu2O3, Tm:Y2O3, and Tm:Sc2O3;
d) said VBG being arranged to restrict lasing in said laser oscillator to a wavelength of 1944.537±0.100 nm measured in air at standard conditions; and
e) said FQS comprising a first harmonic converter stage and a second harmonic converter stage wherein laser light resulting from said lasing at said 1944.537±0.100 nm arranged to be converted in said FQS to a wavelength in the vicinity of 486.13 nm measured in air at sea level and corresponding to the vicinity of the H-beta Fraunhofer line.

13. A method of generating narrow band coherent laser radiation with wavelength centered at 486.13 nm corresponding to the Fraunhofer H-beta line comprising the steps of:
a) Operating a laser source including a pump module, a Tm:Lu₂O₃ laser gain material (LGM), a q-switch, a volume Bragg grating (VBG);
b) Temperature tuning the center wavelength of said VBG to four times the wavelength of said Fraunhofer H-beta line;
c) Closing the q-switch shut;
d) Pumping said LGM by said pump module;
e) Storing laser energy in said LGM;
f) Opening said q-switch;
g) Extracting laser power at 1944 nm wavelength from said LGM through said VBG;
h) Converting a portion of said laser power at 1944 nm wavelength to a first harmonic at 972 nm wavelength in said first non-linear crystal;
i) Converting said first harmonic at 972 nm wavelength to a second harmonic at 486 nm wavelength in said second non-linear crystal; and
j) Closing said q-switch shut.
